(19) United States
(12) Patent Application Publication
(10) Pub. No.: US 2007/0064614 A1
(43) Pub. Date: Mar. 22, 2007

(54) Transmission path latency measurement method

(76) Inventor: Masato Kataoka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/571,180

(22) PCT Filed: Sep. 9, 2004
(86) PCT No.: PCT/JP04/13479

§ 371 Date: Nov. 9, 2006

(30) Foreign Application Priority Data
Sep. 9, 2003 (JP) 2003-316441

(51) Int. Cl. H04J 1/16

(52) U.S. Cl. 370/250; 370/252

(57) ABSTRACT

The invention provides a transmission latency measurement method which measures a transmission latency between a first data transmitting device and a second data transmitting device interfacing to each other by using three kind of signal patterns A, B, and C. When the signal pattern A is received, a transmitting signal is modified to the second signal pattern B. When the signal pattern B is received, a transmitting signal is modified to the signal pattern C. When the signal pattern C is received, a transmitting signal is modified to the signal pattern A. The transmission latency is measured by transmitting and receiving a signal between the first data transmission device and the second data transmission device so that when any one of the signal patterns A, B, and C is not detected among the received signals or when two or more signal patterns are synchronously detected among the signal patterns A, B, and C, a signal pattern of a transmitting signal existing immediately before is maintained, thereby realizing a transmission path latency measurement method which can easily measure the transmission latency on the digital transmission path not requiring a preparation work for the measurement between two data transmission devices, a complicated protocol or another synchronization device.

1. TECHNICAL FIELD

The present invention relates to a transmission path latency measurement method. In particular, the invention relates to a transmission path latency measurement method which measures transmission latency between two transmission devices on a digital transmission path.

2. Background Art

Conventionally, telephone has been used as the most common usage form of a communication network. If the telephone is connected once, the communication path is fixedly allocated to each user. Such a communication form is called as connection type.

Currently, a data communication represented by Internet has become a mainstream as a form of utilization of the communication network. The communication protocol TCP/IP which has been used on Internet divides the original data into units called as packets and respectively exchanges each packet so as to transmit the whole data to the other party. Such a communication form is called as connectionless type.

In the communication form called as connectionless type, transmission path latency is accumulated by each individual packet exchange. As shown in FIG. 4, as an amount of the data to be transmitted is getting larger, the total amount of transmission path latency to be accumulated is getting larger. Accordingly, in order to transmit data, at least the period, which corresponds to a multiplication of a transmission path latency of reciprocation and the number of packets, will be the total amount of latency. In these days, various and high-capacity data such as images or voices are being transmitted and it is an extremely important issue for a network operator (for example, a communication service provider or a person in charge of a business information system) to recognize the transmission path latency.

Currently, a loop method has been most widely used for measuring the transmission path latency. The loop method is a transmission path latency measurement method by forming a loop at a point between two data transmission devices, transmitting a unique digital pattern from one party toward the loop point, and measuring a time from the moment when the digital pattern is transmitted to the moment when the digital pattern is returned from the loop point. As the digital pattern being used, any unique pattern in a measurement system, for example a pattern in which a ‘0’ is inserted in a bit stream of continuous ‘1’s at predetermined intervals, can be used.

Instead of the loop method, as the transmission path latency measurement method which has been widely used, there is a well-known method ‘ping’ which uses a data transmission device such as a computer. The ‘ping’ is a protocol that transmits a request packet with respect to a data terminal device of the opposite party so that the data terminal device of the opposite party, which receives the request packet, returns the same data with the request packet with respect to the data terminal device which is the transmission source of the request packet. The data terminal device of the transmission source measures a time until the request packet transmitted by the data terminal device itself returns, and considers the measured time as a latency. The ‘ping’ is technically located in IP layer which is a higher-level protocol than the transmission layer (for example, refer to Non-patent document 1).

Furthermore, there is a method called as a time stamp method in addition to the above-described methods. In the time stamp method, first, a data transmission device of a transmitting part transmits time information at the time of the transmission with respect to a data transmission device of an opposite part. The data transmission device of the opposite part calculates a difference between a time recorded in the received time information and an arrival time and considers the calculated difference as a latency. In the time stamp method, it is assumed that the time information which both data transmission devices of the transmission part and the opposite part include is extremely accurate. A GPS dock, for example, has been used as a time information source in order to obtain the accurate time information.

The above-described three methods have been widely known to a person having ordinary skill in the art.

The transmission path latency measurement method according to the loop method requires sending a request to the opposite party to make a loop. Accordingly, there is a problem that it involves a manual work to prepare the environment where the method is applicable. In addition, the data terminal device of the opposite party which provides the loop cannot check a measurement result.

In the above-described ‘ping’, since the ‘ping’ is a protocol located in a high-level layer such as TCP/IP, it is assumed to use a data terminal device such as a computer. That is, a data transmission device which configures a transmission path does not include a function for processing a protocol in the high-level layer such as the TCP/IP. Accordingly, it is difficult to execute the ‘ping’.

In addition, as described above, since the transmission path latency measurement method according to the above-described time stamp method requires to be combined with a technology such as the GPS clock in order to synchronize the time of two data transmission devices, the device may become complicated and cause high cost.

Non-patent Document 1: “A Primer On Internet a TCP/IP tools and Utilities”, Request for Comments, (America), IETF (Internet Engineering Task Force), June 1997, RFC2151 3. 2. p. 6

### DISCLOSURE OF THE INVENTION

The invention has been finalized in consideration of the above-described problems, and it is an object of the invention to provide a simple transmission path latency measurement method not requiring a preparation work for the measurement, a complicated protocol or another synchronization device.

In order to solve above-described problems, according to a first aspect of the invention, there is provided a transmission path latency measurement method which measures a latency on a digital transmission path between a first data transmission device and a second data transmission device interfacing to each other by using three signal patterns such as a signal pattern A, a signal pattern B, and a signal pattern C. The transmission path latency measurement method includes: when the signal pattern A is detected among received signals, modifying a transmitting signal to the signal pattern B; when the signal pattern B is detected among the received signals, modifying a transmitting signal to the signal pattern C; when the signal pattern C is detected among the received signals, modifying a transmitting signal to the signal pattern A; when any one of the signal pattern A, the signal pattern B, and the signal pattern C is not detected among the received signals or when two or more signal patterns among the signal pattern A, the signal pattern B, and the signal pattern C are synchronously detected among the signal patterns, transmitting and receiving a signal between the first data transmission device and the second data transmission device so as to maintain a signal pattern of a transmitting signal existing immediately before; and measuring a time between the moment when the signal pattern A is transmitted and the moment when the signal pattern B is detected, a time between the moment the signal pattern B is transmitted and the moment when the signal pattern C is detected, and a time between the moment when the signal pattern C is transmitted and the moment when the signal pattern A is detected as a latency between the transmission paths.

In addition, according to a second aspect of the invention, in the transmission path latency measurement method according to the first aspect of the invention, the three or more kinds of signal patterns may be a pseudo random pattern.

In addition, according to a third aspect of the invention, a transmission path latency measurement device includes: a transmission timing pulse output unit which outputs a transmission timing pulse; a signal pattern A output unit which generates and outputs a signal pattern A in accordance with an input of the transmission timing pulse; a signal pattern B output unit which generates and outputs a signal pattern B in accordance with an input of the transmission timing pulse; a signal pattern C output unit which generates and outputs a signal pattern C in accordance with an input of the transmission timing pulse; a transmitting signal output unit which selects a signal pattern from any one of the signal pattern A, the signal pattern B, and the signal pattern C input by the signal pattern A output unit, the signal pattern B output unit, and the signal pattern C output unit, respectively; a signal pattern A detection unit which output a detection signal when the signal pattern A is detected among the received signals; a signal pattern B detection unit which output a detection signal when the signal pattern B is detected among the received signals; a signal pattern C detection unit which output a detection signal when the signal pattern C is detected among the received signals; an output signal selection unit which outputs a selection signal with respect to the transmitting signal output unit in accordance with the detection signal input from the signal pattern A detection unit, the signal pattern 8 detection unit, and the signal pattern C detection unit; and a transmission path latency calculation unit which calculates a transmission path latency by using the transmission timing pulse and the selection signal. The output signal selection unit outputs the selection signal with respect to the transmitting signal output unit such that the transmitting signal is modified to the signal pattern B when only the signal pattern A is received as the received signal, outputs the selection signal with respect to the transmitting signal output unit such that the transmitting signal is modified to the signal pattern C when only the signal pattern B is received as the received signal, and outputs the selection signal with respect to the transmitting signal output unit such that the transmitting signal is modified to the signal pattern A when only the signal pattern C is received as the received signal.

Further, according to a fourth aspect of the invention, in the transmission path latency measurement device, the transmission path latency calculation unit calculates a difference between the transmission starting time of the signal pattern A and a detection starting time of the signal pattern B, a difference between the transmission starting time of the signal pattern B and a detection starting time of the signal pattern C, and a difference between the transmission starting time of the signal pattern C and a detection starting time of the signal pattern A as a transmission path latency from the selection signal output from the output signal selection unit. According to a fifth aspect of the invention, in the transmission path latency measurement device, the signal pattern A, the signal pattern B, and the signal pattern C may be a pseudo random pattern. According to a sixth aspect of the invention, in the transmission path latency measurement device, the signal pattern A output unit, the signal pattern B output unit, the signal pattern C output unit, the signal pattern A detection unit, the signal pattern B detection unit, and the signal pattern C detection unit may include a shift register and an exclusive logic operator.

In addition, according to a seventh aspect of the invention, a data transmission device includes the transmission path latency measurement device as a transmission path latency measurement unit. According to an eighth aspect of the invention, a semiconductor chip includes the transmission path latency measurement device

In addition, according to a ninth aspect of the invention, a method of detecting the formation of a loop on a transmission path by using the transmission path latency measurement method includes: selecting at least one signal pattern among from the first signal pattern to the last signal pattern; and determining that with respect to the selected signal pattern a loop is formed on the transmission path when a phase difference between a transmission starting time when the selected signal pattern is selected as a transmitting signal and a time when a signal pattern is detected from the received signal is included in a predetermined range. Further, according to a tenth aspect of the invention, in the method of detecting the formation of the loop on a transmission path, the selected signal pattern may be a pseudo random pattern.

In addition, according to an eleventh aspect of the invention, there is a provided a device for detecting the formation of a loop on a transmission path by using the transmission path latency measurement method. At least one signal pattern among the signal pattern A, the signal pattern B, and the signal pattern C is selected, and, when with respect to the selected signal pattern a phase difference between a transmission starting time when the selected signal pattern is selected as a transmitting signal and a time when a signal pattern is detected from the received signal is included in a predetermined range, it is determined that a loop is formed on the transmission path. According to a twelfth aspect of the invention, in the device for detecting the formation of a loop on a transmission path, the signal pattern A, the signal pattern B, and the signal pattern C may be a pseudo random pattern.

In addition, according to a thirteenth aspect of the invention, a data transmission device includes the device for detecting the formation of a loop on a transmission path as a unit for detecting the formation of a loop on a transmission path. According to a fourteenth aspect of the invention, a semiconductor chip includes the device for detecting the formation of a loop on a transmission path.

### BRIEF DESCRIPTION OF THE DRAWINGS

FIG. 1 is a view illustrating a state transition of a transmitting signal of a transmission path latency measurement method according to the invention.

FIG. 2 is a view illustrating a configuration of a transmission path latency measurement device according to the invention.

FIG. 3 is a view illustrating examples of a signal pattern transmission unit and a signal pattern detection unit of the transmission path latency measurement device according to the invention

FIG. 4 is a view illustrating relation between a data capacity and a transmission path latency.

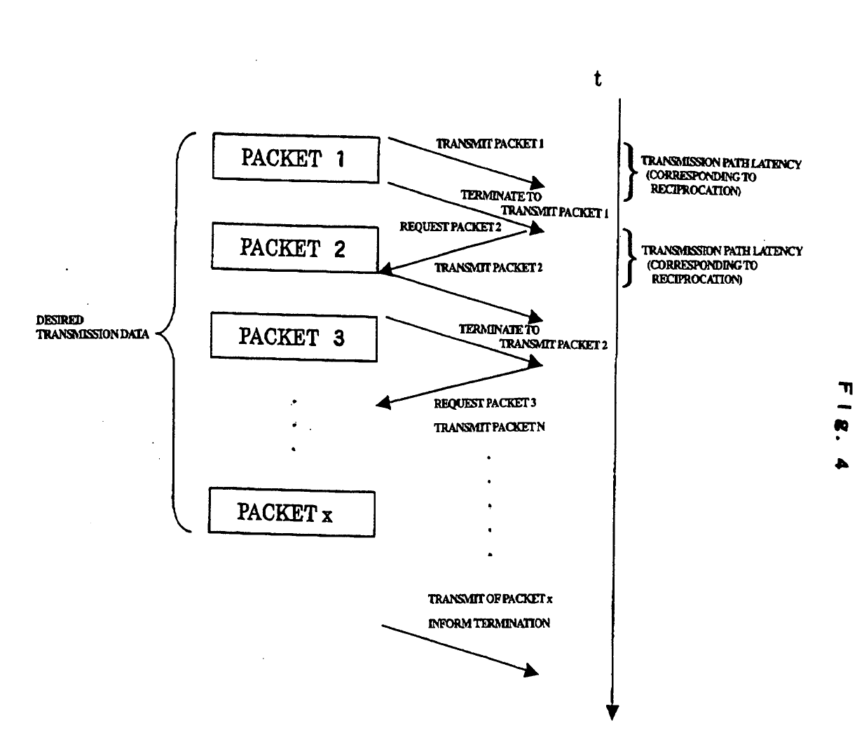

In addition, reference numerals shown In the drawings indicate as follows:
11 transmission timing pulse output unit
12 signal pattern A output unit
13 signal pattern Bb output unit
14 signal pattern C output unit
15 transmitting signal output unit
16 signal pattern A detection unit
17 signal pattern B detection unit
18 signal pattern C detection unit
19 output signal selection unit
20 transmission path latency calculation unit
31 shift register
32 exclusive OR logic circuit

### BEST MODE FOR CARRYING OUT THE INVENTION

In a transmission path latency measurement method according to the invention, a plurality kinds of signal patterns is used so as to measure a latency on a digital transmission path between a first data transmission device and a second data transmission device interfacing to each other. In the transmission path latency measurement method according to the invention, three or more signal patterns are used. A principle of the transmission path latency measurement method according to the invention will be described with three or more signal patterns. Here, three kinds of patterns are used for the description and named as a signal pattern A, a signal pattern B, and a signal pattern C, respectively. In addition, even if four or more kinds of signal patterns are used, it is possible to measure transmission path latency in the same way as the case using the three kinds of signal patterns.

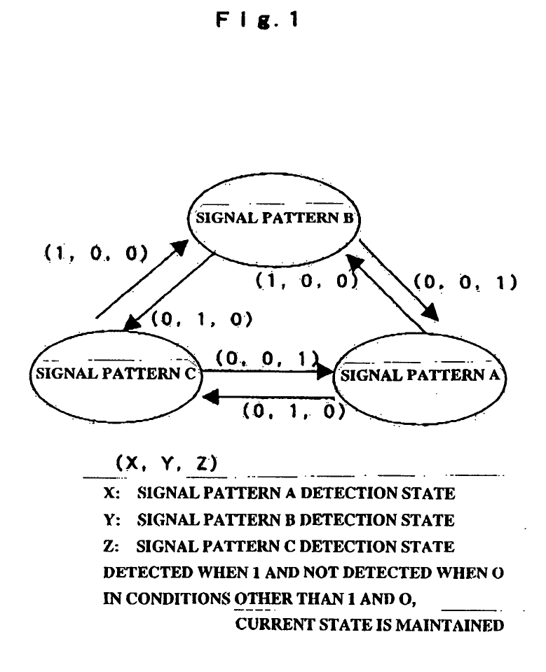

FIG. 1 is a view illustrating a state transition of a transmitting signal of a transmission path latency measurement method according to the invention. As shown in FIG. 1 between a first data transmission device and the second data transmission device, if a signal pattern A is detected among the received signals, a transmitting signal is modified to a signal pattern B, if a signal pattern B is detected among the received signals, a transmitting signal is modified to a signal pattern C, and if a signal pattern C is detected among the received signals, a transmitting signal is modified to a signal pattern A. In addition, a signal pattern of the transmitting signal existed immediately before is maintained in the case that any one of the signal pattern A, the signal pattern B, and the signal pattern C among the received signals is not detected, or at least two of the signal pattern A, the signal pattern B, and the signal pattern C among the received signals are simultaneously detected.

As described above, while transmitting and receiving a signal between the first data transmission device and the second data transmission device, a time T_{AB} between the moment when the signal pattern A is transmitted and the moment when the signal pattern B is detected, a time T_{BC} between the moment when the signal pattern B is transmitted and the moment when the signal pattern C is detected, or a time TCA between the moment when the signal pattern C is transmitted and the moment when the signal pattern A is detected are measured as a latency between the transmission paths. At this moment, the time T_{AB}, T_{BA}, and T_{CA} indicate a transmission path reciprocation latency between the first data transmission device and (lie second data transmission device and values thereof are approximately equivalent to each other.

Although any of unique patterns capable of being respectively identified can be used as the signal pattern A, the signal pattern B, or the signal pattern C, it is preferable to use a pseudo random pattern. For example, ITU-T recommendation O.152 recommends a pseudo random pattern including a random bit stream of 2047 bit cycle for measuring a bit error rate.

Since a pseudo random pattern can be generated and detected by logic circuit of shift registers and hence can be implemented as hardware. In this case, there is an advantage that the pseudo random pattern can be generated and detected in high speed. In a pseudo random pattern generation unit or a pseudo random pattern detection unit, a cycle of the pseudo random pattern bit stream is determined by the number of orders, that is, the number of shift registers. The 2047 bit stream recommended by the ITU-T recommendation O.152 can be realized by an eleven-order shift register circuit.

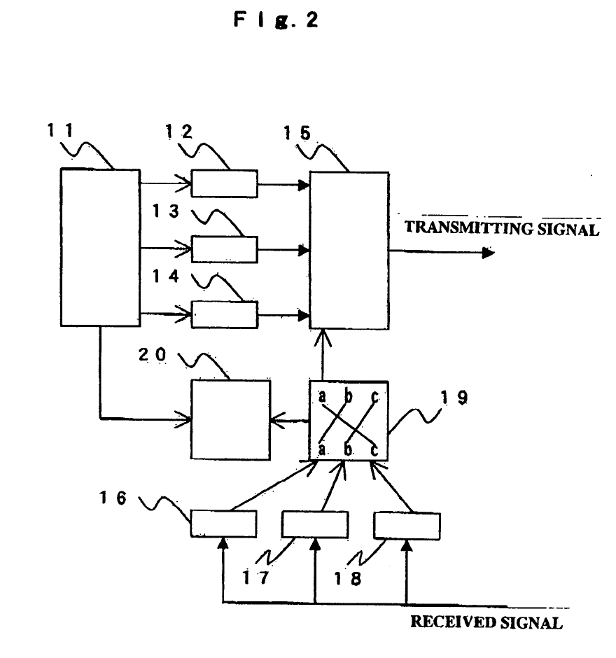

FIG. 2 is a view illustrating a configuration of a transmission path latency measurement device for realizing the transmission path latency measurement method according to the invention. The transmission path latency measurement device according to the invention includes a transmission timing pulse output unit 11, a signal pattern A output unit 12, a signal pattern B output unit 13, a signal pattern C output unit 14, a transmitting signal output unit 15, a signal pattern A detection unit 16, a signal pattern B detection unit 17, a signal pattern C detection unit 18, an output signal selection unit 19, and a transmission path latency calculation unit 20. The transmission path latency measurement device may be arranged to oppose to another transmission path latency measurement device through the transmission path so as to measure a reciprocation latency of the transmission path.

A transmission timing pulse is output from the transmission timing pulse output unit 11 and is input to the signal pattern A output unit 12, the signal pattern B output unit 13, and the signal pattern C output unit 14. The signal pattern A output unit 12, the signal pattern B output unit 13, and the signal pattern C output unit 14 generate and output their unique signal patterns, that is, a signal pattern A, a signal pattern B, and a signal pattern C, respectively. The signal pattern A, the signal pattern B, and the signal pattern C output from the signal pattern A output unit 12, the signal pattern B output unit 13, and the signal pattern C output unit 14, respectively, are input to the transmitting signal output unit 15. The transmitting signal output unit 15 selects any one of among the input signal pattern A, the input signal pattern B, or the input signal pattern C, as a transmitting signal, and outputs the selected signal pattern with respect to the transmission path.

The signal pattern A detection unit 16 detects the signal pattern A from received signals received from the transmission path. When the signal pattern A detection unit 16 detects the signal pattern A, a detection signal is output. In the same way, when the signal pattern B detection unit 17 detects the signal pattern B or the signal pattern C detection unit 18 detects the signal pattern C, corresponding detection signals are output, respectively.

The detection signal output from the signal pattern A detection unit 16, the signal pattern B detection unit 17, or the signal pattern C detection unit 18 is input to the output signal selection unit 19. The output signal selection unit 19 outputs a selection signal with respect to the transmitting signal output unit 15 in accordance with a state of the input detection signal. The transmission path latency calculation unit 20 calculates the transmission path latency from the transmission timing pulse and the selection signal.

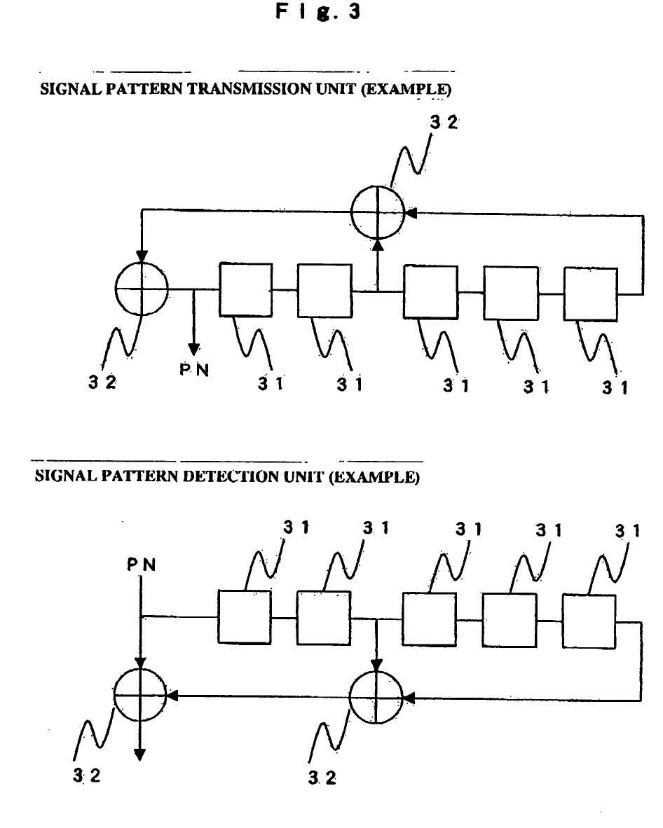

Although, any one of unique signals can be the signal pattern A, the signal pattern B, and the signal pattern C output from the signal pattern A output unit 12, the signal pattern B output unit 13, and the signal pattern C output unit 14, respectively, it is preferable that a pseudo random pattern be used. If the pseudo random pattern is used for the transmitting signal, it is preferable that a logic circuit including a shift register 31 and an exclusive OR logic circuit 32 configures the signal pattern A output unit 12, the signal pattern B output unit 13, the signal pattern C output unit 14, the signal pattern A detection unit 16, the signal pattern B detection unit 17, and the signal pattern C detection unit 18 as shown in FIG. 3. The three kinds of patterns can be generated and detected in an extremely high speed by including the above-described logic circuit.

In the case that only the signal pattern A is received as the received signal, the output signal selection unit 19 outputs the selection signal with respect to the transmitting signal output unit 15 such that the transmitting signal is modified to the signal pattern B. In the case that only the signal pattern B is received as the received signal, the output signal selection unit 19 outputs the selection signal with respect to the transmitting signal output unit 15 such that the transmitting signal is modified to the signal pattern C. In addition, in the case that only the signal pattern C is received as the received signal, the output signal selection unit 19 outputs the selection signal with respect to the transmitting signal output unit 15 such that the transmitting signal is modified to the signal pattern A. The transmission path latency calculation unit 20 measures a time or outputting a selection signal which selects a signal pattern A as a transmitting signal by a selection signal output unit, a time of outputting a selection signal which selects a signal pattern B as a transmitting signal by the selection signal output unit, and a time of outputting a selection signal which selects a signal pattern C as a transmitting signal by the selection signal output unit. The transmission path latency calculation unit 20 considers each of the times as the transmission path latency.

The above-described transmission path latency measurement device can be included in a general data transmission device as a transmission path latency measurement unit. In addition, it is preferable that the transmission path latency measurement device according to the invention is made of a semiconductor chip as a preferable embodiment.

In addition, when measuring the transmission path latency, a time required for the signal pattern detection between the two transmission path latency measurement devices becomes an error. However, in the invention, the number of bits necessary for the detection is extremely small, for example, a few dozen of bits. For example, even in the case of a transmission path of 64 kbps, the time until the time required for the detection becomes the error is about 1 millisecond. Accordingly, it is possible to measure the transmission path latency with all accuracy which is sustainable to be used.

In order to exactly measure the transmission path latency, it is preferable to reduce the time corresponding to:

(number of bits necessary for detection)×(interval of transmission timing pulse)×2 from the transmission path latency calculated above.

In the invention, three kinds of signal patterns have been used so as to compulsorily change the state despite an initial state of a shift register which configures the signal pattern output unit. For example, if two kinds of signal patterns are used, there may be a problem that the two signal pattern output units continuously transmit different patterns.

In the case that the pseudo random patterns are used as the three kinds of signal patterns, a selection manner is basically free. However, being described in detail in an example which will be described later, it is preferable that at least one among the three kinds of signal patterns be set to a long cycle length so as to detect a loop formed on the transmission path. In particular, it is preferable that the cycle length be set to about at least 2¹⁰ to 2²⁰ bit stream.

It is possible to detect the loop formed on the transmission path by applying the transmission path latency measurement method according to the invention. In particular, at least one signal pattern among the signal pattern A, the signal pattern B, and the signal pattern C is selected and an existing phase difference is measured between a received signal and a transmitting signal with respect to the selected signal pattern. If the phase difference of the selected signal pattern is included in a predetermined range, it is determined that a loop is formed on the transmission path. Accordingly, in the transmission path latency measurement device according to the invention, it is possible to detect the loop formed on the transmission path in which the transmission path latency measurement device is installed by including a phase measurement unit for measuring the existing phase difference between the received signal and the transmitting signal with respect to the at least one signal pattern among a plurality of signal patterns used when measuring the transmission path latency.

Hereinbefore, the invention has been described with reference to the above-mentioned embodiments. However, the present invention can be implemented in different forms without being limited to the above-mentioned embodiment. In particular, the transmission path latency measurement method according to the invention can be used as a communication protocol capable of being installed in various communication apparatuses as a part of the embodiment according to the invention.

The invention includes above-described properties. Hereinafter, the invention will be displayed and described in detail by way of examples.

### EXAMPLE 1

Hereinbefore, the operation of the transmission path latency measurement according to the invention has been described in detail. Hereinafter, a function to be incidentally obtained according to the invention will be described. This function can be considered that it is extremely useful to a network operator such as a communication service provider.

When a normal communication state is realized on a transmission path between a transmission path latency measurement device X and a transmission path latency measurement device Y according to the invention, a transmission path latency measurement device Z according to the invention can measure a transmission path latency between the transmission path latency measurement device X and the transmission path latency measurement device Z or between the transmission path latency measurement device Y and the transmission path latency measurement device Z by setting the transmission path latency measurement device Z on the transmission path to perform an only monitoring function while not intervening in the communication between the transmission path latency measurement device X and the transmission path latency measurement device Y. The transmission path latency measurement device Z monitors a transmitting signal from the transmission path latency measurement device X and a received signal from the transmission path latency measurement device Y, and detects a signal pattern A from the transmission path latency measurement device X before detecting a signal pattern B from the transmission path latency measurement device Y, detects signal pattern B from the transmission path latency measurement device X before detecting a signal pattern C from the transmission path latency measurement device Y, or detects signal pattern C from the transmission path latency measurement device X before detecting a signal pattern A from the transmission path latency measurement device Y. Accordingly, the transmission path latency measurement device Z can measure the transmission path latency from a monitoring point where the transmission path latency measurement device Z is set to the transmission path latency measurement device Y. In the same way, it is also possible to measure the transmission path latency from the monitoring point where the transmission path latency measurement device Z is set to the transmission path latency measurement device X by monitoring a transmitting signal from the transmission path latency measurement device Y and a received signal from the transmission path latency measurement device X.

For example, in the case that the transmission path latency measurement device X and the transmission path latency measurement device Y are used by an end user, the communication service provider can check a line to be provided to the end user by setting the transmission path latency measurement device Z.

### EXAMPLE 2

A function to be incidentally obtained according to the invention will be further described. Similarly to the example 1, this function can be considered that it is extremely useful to the network operator such as a communication service provider.

If a loop is formed on a transmission path being operated, an end-end communication receives interference. However, in most cases, since a transmission device becomes a no-alarm state during the loop, the network operator considers that the communication is normally operated. Since an abnormal loop has not been detected, it is easy for the interference state to be continued for a long time.

It is a destiny of a transmission layer that the abnormal loop is not detected and the alarm is not issued. First of all, it is assumed that two data transmission devices can be symmetrically opposed to each other for the data transmission in a protocol of the transmission layer. Accordingly, in current technologies, if a transmitting signal of the transmission device itself and a transmitting signal of the other transmission device have the same specification, it is difficult to immediately determine whether the received signal is a signal transmitted from a normal transmission device, or a transmitting signal from the transmission device itself looped by a loop existing on the transmission path.

Even though the preparing the loop has above-described risk, the loop has been in a heavy usage regardless of before or after opening the transmission path in order to check quality/connectivity of the transmission path for maintenance. By forming the loop, the number of measurement apparatuses necessary for the measurement is enough with one on the one side. In addition, it is easy to specify an interference region by modifying a loop place. However, there are many cases that the prepared loop is left or the loop is formed in an unnecessary location because of lack of connection between people in a charge of the maintain. In these cases, it shows a tendency that the interference state is continued for a long time. According to the above-described reason, it is considered that the loop detection is highly necessary on the transmission layer.

As above described, even though a loop exists on the transmission path, it is impossible to detect the existing loop. Accordingly, in the related art, a predetermined preprocess should be performed in order to detect the loop.

As one example of the preprocess, there is a well-known method that a channel for the maintenance is regularly prepared so as to write a transmission path name different from each other on the channel. For example, in a transmission path which connects between Tokyo and Osaka, ‘TYO-OSA’ is written in a channel transmitted from Tokyo and ‘OSA-TYO’ is written in a channel transmitted from Osaka. If a device installed in Tokyo receives a signal besides ‘OSA-TYO’, it is considered that there is an abnormal condition on the transmission path. In particular, if the received signal includes ‘TYO-OSA’, it is considered that a loop is formed on the transmission path.

As a real example, in the ITU-T recommendation G. 707, J1 byte is described as a channel for writing a transmission path name. Fifteen characters can be written by using the J1 byte.

When writing the transmission path name by using the J1 byte, the transmission path name should be determined by a preliminary discussion with the opposite part. However, in the case of an interconnection between different service providers, the J1 byte may be not in use while being in a state of blank. Originally, a method of calling a transmission path name is all different according to the service provider and it is extremely difficult to reach a settlement of a method of calling the individual transmission path name at the time of the interconnection. Since it is considered that the connection of the transmission path is an urgent business from a view of commercial, it is extremely difficult to set an enough time for the settlement of the calling method. Accordingly, it must be considered that performing the above-described preprocesses in the method of detecting the loop formation has poor practicality and utility.

Even in the transmission path latency measurement device according to the invention, when the loop is formed on the transmission path, the operation looks normal at the first glance. That is, the operation of transmitting the signal pattern A and receiving the signal pattern A returned by the loop, transmitting the signal pattern B and receiving the signal pattern B returned by the loop, and transmitting the signal pattern C and receiving the signal pattern C returned by the loop is repeated. At this time, the measured transmission path latency becomes two times of the state of two transmission path latency measurement devices interfacing to each other but it is not possible to detect the formation of the loop by only measuring the transmission path latency because the operation looks normal regardless of the fact that the transmission path latency becomes two times.

However, the formation of the loop can be detected by employing at least one of the signal pattern A, the signal pattern B, and the signal pattern C as the pseudo random pattern of long cycle length.

On the other hand, even though the signal pattern A, the signal pattern B, and the signal pattern C generated in the data transmission device X have the same signal stream with the signal pattern A, the signal pattern B, and the signal pattern C generated in the other data transmission device Y, the phase thereof does not accord to each other. If the initial state of data transmission device X and the data transmission device Y is regarded random, in order to correspond the phases thereof, it is necessary special and inconsequent try such as turning power on completely at the same time for the data transmission device X and the other data transmission device Y which are different from each other.

In a normal interfacing state, if the data transmission device X supposedly transmits the signal pattern A at the beginning, the signal pattern B is received from the data transmission device Y after a predetermined time. In addition, if the data transmission device X transmits the signal pattern C at the beginning, the signal pattern A is received from the data transmission device Y. At this time, the possibility that the phase when the data transmission device X transmits the signal pattern A at the beginning accords completely to the phase when the signal pattern A received from the data transmission device Y at the end is detected is 1(cycle of the signal pattern A). If the loop is formed, since the signal pattern A received at the end is regarded as the signal pattern A received from the data transmission device X, the phases thereof are accorded with each other. Accordingly, if the cycle of the signal pattern is sufficiently long, the probability that the phases thereof accord to each other in the normal interfacing state is extremely low. Further, it is reasonable to use the accordance of the phase as a condition for determining the formation of the loop on the transmission path. In addition, the phase can be displayed by using a state of the shift register. Accordingly, determining the accordance of the phase is identical to checking whether the state of the shift register of the output unit accords to the state of the shift register of the detection unit.

However, it is difficult to definitely detect the signal pattern A, the signal pattern B, and the signal pattern C per every one hit. The number of bits necessary for the signal pattern detection (phase comparison) is about two times of the number of shift registers. That is, in the pseudo random pattern generated by the number shift register, the cycle becomes 2ⁿ−1 and the number of bits necessary for the detection becomes about 2×n. Accordingly, in the normal interfacing state, the probability of misunderstanding that the phase of signal pattern A is accorded and the loop is formed becomes 2n/(2ⁿ−1). In addition, the probability of misunderstanding can be extremely low value by considerably enlarging n. If the signal pattern A is a bit stream having a cycle of 2¹³×1, the probability of misunderstanding becomes 0.003 whose order is 10⁻³. If another signal pattern B is a bit stream having a cycle of 2¹⁷×1 and the signal pattern C is a bit stream having a cycle of 2¹⁹×1, the probability that all of the phases of the three signal patterns accord to one another becomes an order of 10⁻¹¹ and the probability of misunderstanding can be extremely lowered. As like this, it is possible to detect the formation of the loop on the transmission path with a high-accuracy by using a signal pattern having a cycle of about 2¹⁰ to 2²⁰.

As described above, the transmission path latency calculated when the loop is formed becomes two times of the real transmission path latency. However, since the loop is detected independent of the latency, it is possible to obtain the latency to the point where the loop is formed by simply considering the transmission path latency as ½ times. Accordingly, it becomes easy to estimate the point where the loop is formed.

### INDUSTRIAL APPLICABILITY

According to the invention, it is possible to provide a simple transmission path latency measurement method not requiring a preparation work for the measurement, a complicated protocol or another synchronization device.

In addition, in the related art, a latency measurement result can be obtained only at one end of the digital transmission path. However, according to the invention, the latency measurement result can be obtained at both ends of the digital transmission path.

In the invention, the transmission path latency measurement can be realized by using hardware including a shift register as a basic configuration and a high-speed process can be realized without using a complicated protocol.

There is a case that the data is received or transmitted through an absolutely different route in the data transmission. In this case, the transmission path latency when transmitting the data may greatly differ from the transmission path latency when receiving the data. However, the invention can manage such a case and further perform the transmission path latency measurement regardless of a fluctuation of the transmission speed. In addition, the accuracy of the transmission path latency measurement according to the invention is a few milliseconds on the most general 64 kbit/second transmission path. That is, the invention realizes an extremely accurate transmission path latency measurement.

In addition, the invention can realize the detection of the loop on the transmission path, which has been not possible or very difficult in the related art. Hereinbefore, as described in detail, the invention provides a transmission path latency measurement method which provides a simple transmission path latency measurement method not requiring a preparation work for the measurement, a complicated protocol or another synchronization device. In addition, the invention also provides a method of detecting the formation of a loop on a physical layer that is considered that it is impossible in the related art.

The data communication represented by the internet has become a mainstream a form of utilization for the communication network and various high-capacity data such as images or voices needs to be transmitted. Accordingly, it is an extremely important issue for network operators, such as a communication service provider or a person in charge of a business information system, to recognize transmission path latency. The invention is strongly expected to be realized as the invention provides highly accurate and simple transmission path latency measurement method and, in addition, the invention provides useful functions to network operators.

1. A transmission path latency measurement method which measures a latency on a digital transmission path between a first data transmission device and a second data transmission device interfacing to each other by using three or more kinds of signal patterns, the transmission path latency measurement method comprising:
when a first signal pattern is detected among received signals, modifying a transmitting signal to a second signal pattern;
when the second signal pattern is detected among the received signals, modifying a transmitting signal to a third signal pattern;
when a signal pattern is detected among the received signals, modifying a signal pattern of a transmitting signal;
when a last signal pattern is detected among the received signals, modifying a transmitting signal to the first signal pattern;
when any one of the signal patterns is not detected among the received signals or when two or more signal patterns are synchronously detected among the signal patterns, transmitting and receiving a signal between the first data transmission device and the second data transmission device so as to maintain a signal pattern of a transmitting signal existing immediately before; and
measuring a time between the moment when the first signal pattern is transmitted and the moment when the second signal pattern is detected, a time between the moment when the second signal pattern is transmitted and the moment when the third signal pattern is detected, a time between the moment when the signal pattern is transmitted and the moment when the signal pattern is detected, and a time between the moment when a last signal pattern is transmitted and the moment when the first signal pattern is detected as a latency between the transmission paths.

2. The transmission path latency measurement method according to claim 1, wherein a plurality of signal patterns are pseudo random patterns.

3. A transmission path latency measurement device comprising:
a transmission timing pulse output unit which outputs a transmission timing pulse;
a first signal pattern output unit which generates and outputs a first signal pattern in accordance with an input of the transmission timing pulse;
a third signal pattern output unit which generates and outputs a second signal pattern in accordance with an input of the transmission timing pulse;
an output signal pattern output unit which generates and outputs a signal pattern in accordance with an input of the sequential transmission timing pulse;
a last signal pattern output unit which generates and outputs a last signal pattern in accordance with an input of the transmission timing pulse;
a transmitting signal output unit which selects any one of the first signal pattern to the last signal pattern input by the first signal pattern output unit to the last signal pattern output unit and outputs the selected signal pattern as a transmitting signal;
first to last signal pattern detection units which output a detection signal when the first signal pattern to the last signal pattern are detected among the received signals;
an output signal selection unit which outputs a selection signal with respect to the transmitting signal output unit in accordance with the detection signal input from the first to last signal pattern detection units; and
a transmission path latency calculation unit which calculates a transmission path latency by using the transmission timing pulse and the selection signal,
wherein the output signal selection unit outputs the selection signal with respect to the transmitting signal output unit such that the transmitting signal is modified to the second signal pattern when only the first signal pattern is received as the received signal, outputs sequentially the selection signal with respect to the transmitting signal output unit such that the transmitting signal is modified to the third signal pattern when only the second signal pattern is received as the received signal, and outputs the selection signal with respect to the transmitting signal output unit such that the transmitting signal is modified to the first signal pattern when only the last signal pattern is received as the received signal.

4. The transmission path latency measurement device according to claim 3, wherein the transmission path latency calculation unit determines sequentially a transmission starting time of the first signal pattern, a transmission starting time of the second signal pattern, and a transmission starting time of the last signal pattern, calculates a difference between the transmission starting time of the first signal pattern and a detection starting time of the second signal pattern, a difference between the transmission starting time of the second signal pattern and a detection starting time of the third signal pattern, and a difference between the transmission starting time of the last signal pattern and a detection starting time of the first signal pattern as a transmission path latency, and subtracts (the number of bits necessary for signal pattern detection)×(interval of transmission timing pulse)×2, as a correction value, from the transmission path latency in accordance with a requested value.

5. The transmission path latency measurement device according to claim 3, wherein the three or more signal patterns are pseudo random patterns.

6. The transmission path latency measurement device according to claim 5, wherein the signal pattern output units for the first signal pattern, and the second signal pattern through the last signal pattern, and the signal pattern detection units for the first signal pattern and the second signal pattern through the last signal pattern include a shift register and an exclusive OR logic circuit.

7. A data transmission device comprising the transmission path latency measurement device according to claim 3 as a transmission path latency measurement unit.

8. A semiconductor chip comprising the transmission path latency measurement device according to claim 3.

9. A method of detecting the formation of a loop on a transmission path by using the transmission path latency measurement method according to claim 1, the method comprising:
selecting at least one signal pattern among the first signal pattern to the last signal pattern; and
determining that with respect to the selected signal pattern a loop is formed on the transmission path when a phase difference between a transmission starting time when the selected signal pattern is selected as a transmitting signal and a time when a signal pattern is detected from the received signal is included in a predetermined range.

10. The method of detecting the formation of a loop on a transmission path according to claim 9, wherein the selected signal pattern are a pseudo random pattern.

11. A device for detecting the formation of a loop on a transmission path by using the transmission path latency measurement method according to claim 11, wherein at least one signal pattern is selected among the first signal pattern through the last signal pattern, and when with respect to the selected signal pattern a phase difference between a transmission starting time at which the selected signal pattern is selected as a transmitting signal and a time at which a signal pattern is detected from the received signal is included in a predetermined range, it is determined that a loop is formed on the transmission path.

12. The device for detecting the formation of a loop on a transmission path according to claim 11, wherein the plurality of signal patterns are pseudo random patterns.

13. A data transmission device comprising the device for detecting the formation of a loop on a transmission path according to claim 11 as a unit for detecting the formation of a loop on a transmission path.

14. A semiconductor chip comprising the device for detecting the formation of a loop on a transmission path according to claim 11.

15. The transmission path latency measurement device according to claim 4, wherein the three or more signal patterns are pseudo random patterns.

16. The transmission path latency measurement device according to claim 15, wherein the signal pattern output units for the first signal pattern, and the second signal pattern through the last signal pattern, and the signal pattern detection units for the first signal pattern and the second signal pattern through the last signal pattern include a shift register and an exclusive OR logic circuit.

17. A data transmission device comprising the transmission path latency measurement device according to claim 4 as a transmission path latency measurement unit.

18. A data transmission device comprising the transmission path latency measurement device according to claim 5 as a transmission path latency measurement unit.

19. A data transmission device comprising the transmission path latency measurement device according to claim 6 as a transmission path latency measurement unit.

20. A semiconductor chip comprising the transmission path latency measurement device according to claim 4.
